(19) United States
(12) Patent Application Publication
(10) Pub. No.: US 2026/0298109 A1
(43) Pub. Date: Oct. 1, 2026

(54) TIE-BOLT FOR COUPLING A TURBINE WITH A COMPRESSOR IN A TURBINE ENGINE

(71) Applicant: General Electric Company, Evendale, OH (US)

(72) Inventors: Keith W. Wilkinson, Portsmouth, NH (US); Alexander Joseph Schock, Cincinnati, OH (US)

(73) Assignee: General Electric Company, Evendale, OH (US)

(21) Appl. No.: 19/089,394

(22) Filed: Mar. 25, 2025

(51) Int. Cl. F01D 25/24

(52) U.S. Cl. CPC F01D 25/243; F05D 2260/31

(57) ABSTRACT

A tie-bolt couples a turbine with a compressor in a turbine engine. The tie-bolt includes a body that extends longitudinally along an axis and has an exterior surface and an interior surface that defines a bore extending therethrough along the axis. The tie-bolt further includes threads disposed along the exterior surface of the body and configured to engage at least one of the turbine and the compressor. The tie-bolt further includes an engagement portion adjacent the bore for engagement by a tool extending through the bore.

### TECHNICAL FIELD

The present specification generally relates to tie-bolts for turbine engines and, more specifically, tie-bolts for coupling a turbine with a compressor in a turbine engine.

### BACKGROUND

A typical turbine engine utilizes a compressor and a turbine to generate thrust. The compressor pressurizes a flow of air passing therethrough and directs the pressurized air into a combustion section. In the combustion section, the pressurized air is mixed with fuel and burned to provide combustion gases. The combustion gases are expelled out of the turbine engine to produce thrust, but not before passing along and rotating the turbine. The compressor and the turbine are fixed to one another and rotate in unison such that rotation of the turbine by the combustion gases causes the compressor to compress more air for combustion within the combustion section.

The compressor and the turbine are typically fixed to one another through a retaining nut that engages both the compressor and the turbine and is positioned adjacent the turbine. To engage both the compressor and the turbine, the compressor must include an elongated shaft that extends through a bore of the turbine. However, the elongated shaft of the compressor is prone to torsion. Furthermore, the bore of the turbine must have an enlarged diameter to allow the shaft of the compressor to extend therethrough and to provide access to the retaining nut. The enlarged diameter of the bore compromises the disk load carrying capability and may limit turbine engine rotational speed.

Accordingly, a need exists for alternative tie-bolts for coupling a turbine with a compressor in a turbine engine.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a cross-sectional side view of a turbine engine, taken along a centerline axis of the turbine engine, according to one or more embodiments shown and described herein;

FIG. 2 schematically depicts a partial cross-sectional side view of a rotational assembly for the turbine engine of FIG. 1, according to one or more embodiments shown and described herein;

FIG. 3 schematically depicts a partial cross-sectional side view of the rotational assembly including a second turbine for the turbine engine of FIG. 1, according to one or more embodiments shown and described herein;

FIG. 4 schematically depicts a partial perspective view of a tie-bolt of the rotational assembly and a tool in an extended position, according to one or more embodiments shown and described herein;

FIG. 5 schematically depicts a perspective view of the tool in the extended position, according to one or more embodiments shown and described herein;

FIG. 6 schematically depicts a perspective view of the tool in a retracted position, according to one or more embodiments shown and described herein;

FIG. 7 schematically depicts a partial cross-sectional side view of the rotational assembly with a sleeve of the tool disposed within a bore of the tie-bolt, according to one or more embodiments shown and described herein;

FIG. 8 schematically depicts a partial cross-sectional side view of the rotational assembly with a shaft of the tool disposed with the sleeve, according to one or more embodiments shown and described herein;

FIG. 9 schematically depicts a partial cross-sectional side view of the rotational assembly, with the tool engaging the tie-bolt, according to one or more embodiments shown and described herein; ; and

FIG. 10 schematically depicts a partial cross-sectional side view of the rotational assembly, with the tool engaging and moving the tie-bolt to disconnect the compressor from the turbine, according to one or more embodiments shown and described herein;.

### DETAILED DESCRIPTION

Embodiments described herein are generally directed to a rotational assembly for a turbine engine that includes a turbine rotatable about an axis and defining a turbine bore that extends along the axis and a compressor rotatable about the axis and defining a compressor bore that extends along the axis. The rotational assembly includes a tie-bolt disposed within the turbine bore and the compressor bore for coupling a turbine with a compressor in a turbine engine. The tie-bolt includes a body that extends longitudinally along an axis and has an exterior surface and an interior surface that defines a bore extending therethrough along the axis. The tie-bolt further includes threads disposed along the exterior surface of the body and configured to engage at least one of the turbine and the compressor. The tie-bolt further includes an engagement portion adjacent the bore for engagement by a tool extending through the bore.

In addition, embodiments described herein are also generally directed to a tool for use with the tie-bolt for coupling the turbine with the compressor in the turbine engine. The tool includes a sleeve that extends along an axis between a first sleeve end and a second sleeve end. The sleeve has an external surface and an internal surface defining a bore that extends therethrough along the axis. The sleeve is configured to be disposed within a turbine bore of the turbine and a compressor bore of the compressor. The tool further includes a plurality of fingers spaced circumferentially about, and extending outwardly from, the axis, and a spring in engagement with the plurality of fingers and configured to bias the plurality of fingers toward the axis. The tool further includes a shaft extending along the axis. The shaft is configured to be inserted into the bore of the sleeve at the second sleeve end and move toward the first sleeve end. The shaft is configured to engage and move the plurality of fingers, against the bias of the spring, away from axis from a retracted position to an extended position in which the plurality of fingers extend beyond the external surface of the sleeve for engagement with the tie-bolt.

Previous rotational assemblies utilize a compressor and a turbine that are fixed to one another through a retaining nut that engages both the compressor and the turbine and is positioned adjacent the turbine. To engage both the compressor and the turbine, the compressor must include an elongated shaft that extends through a bore of the turbine. However, the elongated shaft of the compressor is prone to torsion. Furthermore, the bore of the turbine must have an enlarged diameter to allow the shaft of the compressor to extend therethrough and to provide access to the retaining nut. The enlarged diameter of the bore compromises the disk load carrying capability and may limit turbine engine rotational speed. The embodiments described herein overcome these limitations by utilizing the tie-bolt having the bore extending therethrough along the axis, which allows for insertion of the tool therethrough to access the tie-bolt. In turn, the tie-bolt may be disposed further within the turbine engine and may be accessed by the tool through the diameter of the bore itself. As such, labor is reduced in accessing the tie-bolt while the compressor and the turbine may be configured for higher performance. Various embodiments and benefits of rotational assemblies, tie-bolts, and tools for use with the tie-bolts are described in more detail herein. Whenever possible, the same reference numerals will be used throughout the drawings to refer to the same or like parts.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

It is noted that the terms “substantially,” “generally,” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Directional terms as used herein-for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

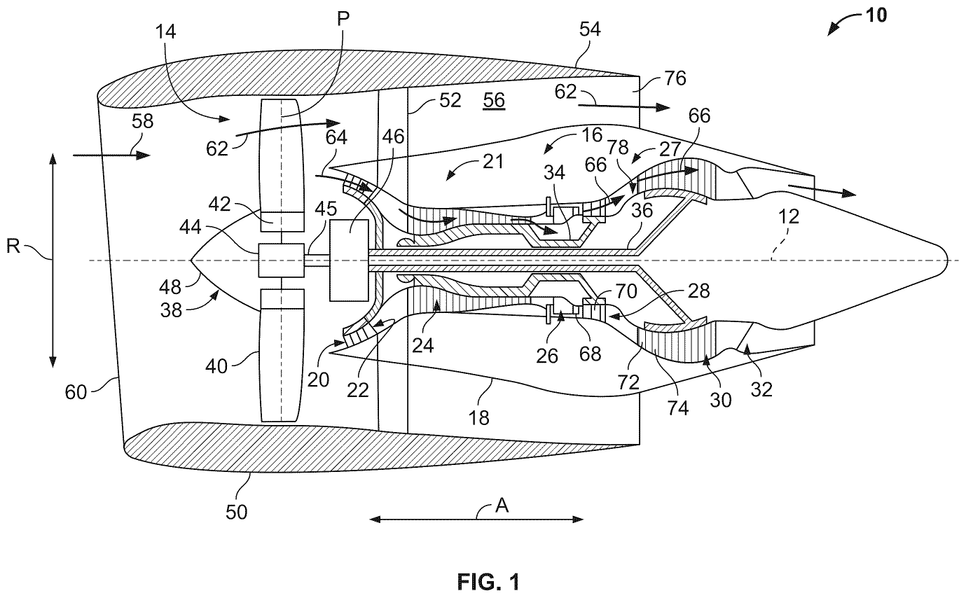

Referring now to the drawings, FIG. 1 depicts a cross-sectional view of a turbine engine 10, taken along a centerline axis of the turbine engine 10, according to an embodiment of the present disclosure. The turbine engine 10 defines an axial direction A (extending parallel to a longitudinal centerline 12 provided for reference) and a radial direction R that is normal to the axial direction A. In general, the turbine engine 10 includes a fan section 14 and a core turbine engine 16 disposed downstream from the fan section 14.

The core turbine engine 16 depicted generally includes an outer casing 18 that is substantially tubular and defines an annular inlet 20. As schematically shown in FIG. 1, the outer casing 18 encases, in serial flow relationship, a compressor section 21 including a booster or a low pressure (LP) compressor 22 followed downstream by a high pressure (HP) compressor 24, a combustion section 26, a turbine section 27 including a high pressure (HP) turbine 28 followed downstream by a low pressure (LP) turbine 30, and a jet exhaust nozzle section 32. A high pressure (HP) shaft 34 or spool drivingly connects the HP turbine 28 to the HP compressor 24 to rotate the HP turbine 28 and the HP compressor 24 in unison. A low pressure (LP) shaft 36 drivingly connects the LP turbine 30 to the LP compressor 22 to rotate the LP turbine 30 and the LP compressor 22 in unison. The compressor section 21, the combustion section 26, the turbine section 27, and the jet exhaust nozzle section 32 together define a core air flowpath.

For the embodiment depicted in FIG. 1, the fan section 14 includes a fan 38 (e.g., a variable pitch fan) having a plurality of fan blades 40 coupled to a disk 42 in a spaced apart manner. As depicted in FIG. 1, the fan blades 40 extend outwardly from the disk 42 generally along the radial direction R. Each fan blade 40 is rotatable relative to the disk 42 about a pitch axis P by virtue of the fan blades 40 being operatively coupled to an actuation member 44 configured to collectively vary the pitch of the fan blades 40 in unison. The fan blades 40, the disk 42, and the actuation member 44 are together rotatable about the longitudinal centerline 12 via a fan shaft 45 that is powered by the LP shaft 36 across a gearbox assembly 46. The gearbox assembly 46 includes a plurality of gears for adjusting the rotational speed of the fan shaft 45 and, thus, the fan 38 relative to the LP shaft 36 to a more efficient rotational fan speed.

Referring still to the exemplary embodiment of FIG. 1, the disk 42 is covered by a rotatable fan hub 48 aerodynamically contoured to promote an airflow through the plurality of fan blades 40. In addition, the fan section 14 includes an annular fan casing or a nacelle 50 that circumferentially surrounds the fan 38 and/or at least a portion of the core turbine engine 16. The nacelle 50 is supported relative to the core turbine engine 16 by a plurality of circumferentially spaced outlet guide vanes 52. Moreover, a downstream section 54 of the nacelle 50 extends over an outer portion of the core turbine engine 16 to define a bypass airflow passage 56 therebetween.

During operation of the turbine engine 10, a volume of air 58 enters the turbine engine 10 through an inlet 60 of the nacelle 50 and/or the fan section 14. As the volume of air 58 passes across the fan blades 40, a first portion of air 62 is directed or routed into the bypass airflow passage 56, and a second portion of air 64 is directed or is routed into the upstream section of the core air flowpath, or, more specifically, into the annular inlet 20 of the LP compressor 22. The ratio between the first portion of air 62 and the second portion of air 64 is commonly known as a bypass ratio. The pressure of the second portion of air 64 is then increased as the second portion of air 64 is routed through the HP compressor 24 and into the combustion section 26, where the highly pressurized air is mixed with fuel and burned to provide combustion gases 66.

The combustion gases 66 are routed into the HP turbine 28 and expanded through the HP turbine 28 where a portion of thermal and/or of kinetic energy from the combustion gases 66 is extracted via sequential stages of HP turbine stator vanes 68 that are coupled to the outer casing 18 and HP turbine rotor blades 70 that are coupled to the HP shaft 34, thus, causing the HP shaft 34 to rotate, thereby supporting operation of the HP compressor 24. The combustion gases 66 are then routed into the LP turbine 30 and expanded through the LP turbine 30. Here, a second portion of thermal and kinetic energy is extracted from the combustion gases 66 via sequential stages of LP turbine stator vanes 72 that are coupled to the outer casing 18 and LP turbine rotor blades 74 that are coupled to the LP shaft 36, thus, causing the LP shaft 36 to rotate. This thereby supports operation of the LP compressor 22 and rotation of the fan 38 via the gearbox assembly 46.

The combustion gases 66 are subsequently routed through the jet exhaust nozzle section 32 of the core turbine engine 16 to provide propulsive thrust. Simultaneously, the pressure of the first portion of air 62 is increased as the first portion of air 62 is routed through the bypass airflow passage 56 before being exhausted from a exhaust section 76 of the turbine engine 10, also providing propulsive thrust. The HP turbine 28, the LP turbine 30, and the jet exhaust nozzle section 32 at least partially define a hot gas path 78 for routing the combustion gases 66 through the core turbine engine 16.

The turbine engine 10 depicted in FIG. 1 is by way of example only. In other exemplary embodiments, the turbine engine 10 may have any other suitable configuration. For example, in other exemplary embodiments, the fan 38 may be configured in any other suitable manner (e.g., as a fixed pitch fan) and further may be supported using any other suitable fan frame configuration. Moreover, it should be appreciated that, in other exemplary embodiments, any other suitable number or configuration of compressors, turbines, shafts, or a combination thereof may be provided. In still other exemplary embodiments, aspects of the present disclosure may be incorporated into any other suitable gas turbine engine, such as, for example, turbofan engines, propfan engines, turbojet engines, and/or turboshaft engines.

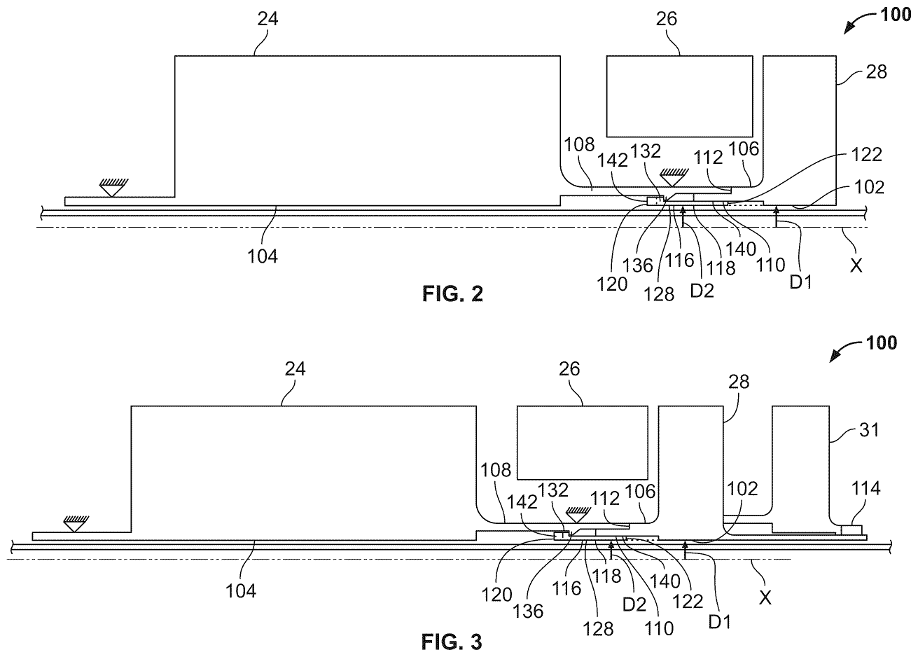

Referring now to FIG. 2, a cross-sectional side view of a rotational assembly 100 for the turbine engine 10 is shown. The rotational assembly 100 includes the turbine 28 rotatable about an axis X and defining a turbine bore 102 that extends along the axis X. The axis X is aligned (e.g., collinear) with the longitudinal centerline 12 described above. The rotational assembly 100 further includes the compressor 24 rotatable about the axis X and defining a compressor bore 104 that extends along the axis X. The turbine 28 and the compressor 24 are fixed to one another along the axis X such that the turbine 28 and the compressor 24 rotate together about the axis X as a single unit. In the embodiment shown in FIG. 2, the turbine 28 is the HP turbine 28 described above and the compressor 24 is the HP compressor 24 described above. However, in other embodiments the rotational assembly 100 may include the LP turbine 30 and/or the LP compressor 22.

As shown in FIG. 2, the turbine 28 may further include a turbine shaft 106 extending along the axis X and the compressor 24 may further include a compressor shaft 108 extending along the axis X and configured to nest with the turbine shaft 106. More specifically, the turbine bore 102 of the turbine 28 extends through the turbine shaft 106 and the compressor bore 104 extends through the compressor shaft 108. As shown in FIG. 2, the turbine shaft 106 includes a neck 110 extending from a wall 112. The neck 110 has an outer diameter that is less than or equal to an inner diameter of a portion of the compressor bore 104 that engages the neck 110. As such, the neck 110 of the turbine shaft 106 may be received within the compressor bore 104. The turbine shaft 106 may move along the axis X toward the compressor 24 until the wall 112 of the turbine shaft 106 abuts the compressor shaft 108, inhibiting further movement of the turbine 28 and the compressor 24 toward one another along the axis X. It is to be appreciated that the compressor 24 and the turbine 28 may engage one another in any suitable manner and configuration.

The rotational assembly 100 further includes a tie-bolt 116 disposed within the turbine bore 102 and the compressor bore 104 for coupling the turbine 28 with the compressor 24 in the turbine engine 10, as shown in FIG. 2. More specifically, the tie-bolt 116 fixes the turbine 28 with the compressor 24 such that the turbine 28 and the compressor 24 rotate in unison about the axis X.

FIG. 3 is a cross-sectional side view of an embodiment in which the rotational assembly 100 further includes a second turbine 31. In this embodiment, the second turbine 31 is a second high pressure turbine stage, which may be similar in construction and configuration to the HP turbine 28 described above. The second turbine 31 is coupled to the turbine 28 by a retaining nut 114. As such, the embodiment illustrated in FIG. 3 is the same as the embodiment shown in FIG. 2, but for the second turbine 31 and the retaining nut 114. Accordingly, the description below may be applicable to both the embodiment shown in FIG. 2 and the embodiment shown in FIG. 3. It is to be appreciated that the second turbine 31 may comprise any turbine for use in the turbine engine 10. Furthermore, the rotational assembly 100 may include any number of compressors and turbines.

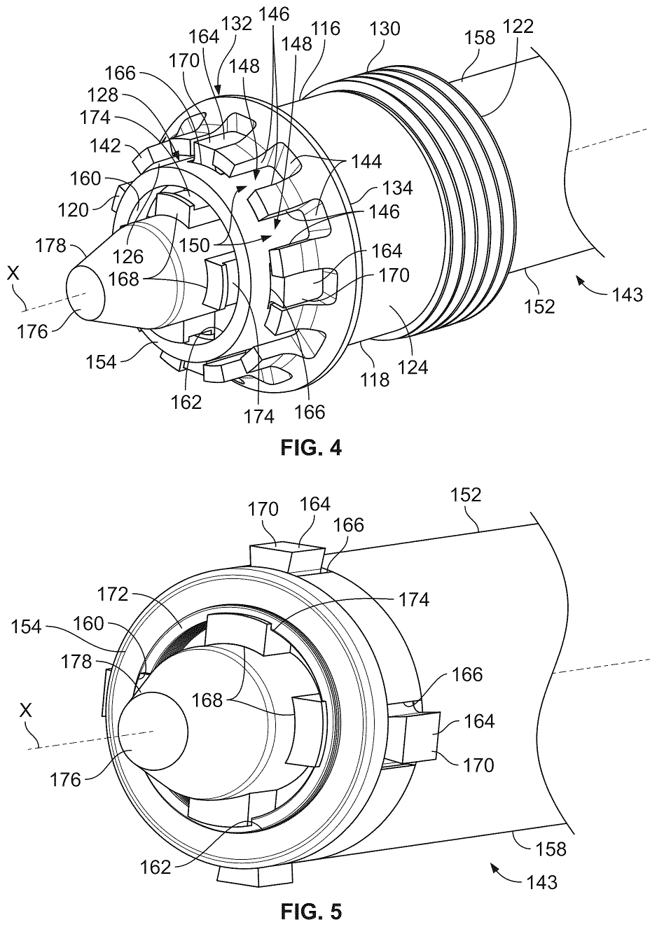

Referring now to FIG. 4, the tie-bolt 116 may include a body 118 that extends longitudinally along the axis X between a first end 120 and a second end 122. The body 118 has an exterior surface 124 and an interior surface 126 that defines a bore 128 extending therethrough along the axis X. Both the exterior surface 124 and the interior surface 126 have a substantially cylindrical configuration such that the body 118 of the tie-bolt 116 is shaped similar to a pipe. Furthermore, the body 118 is sized such that the body 118 may extend longitudinally within the turbine bore 102 and/or the compressor bore 104 (FIG. 2). However, the body 118 of the tie-bolt 116 may have any suitable shape and configuration for coupling the turbine 28 with the compressor 24.

The tie-bolt 116 may include threads 130 disposed along the exterior surface 124 of the body 118 and configured to engage at least one of the turbine 28 and the compressor 24 (FIG. 2). In the embodiment shown in FIG. 4, the threads 130 have a helical configuration about the axis X and positioned along a portion of the exterior surface 124 that is adjacent the second end 122 of the body 118. However, the threads 130 may have any suitable configuration and may be disposed on any suitable portion of the exterior surface 124 for engaging at least one of the turbine 28 and the compressor 24 (FIG. 2).

The tie-bolt 116 may further include a shoulder 132 extending from the body 118 to engage one of the turbine 28 and the compressor 24 (FIG. 2). As shown in FIG. 4, the shoulder 132 extends radially away from the axis X and surrounds the body 118 about the axis X. Accordingly, the shoulder 132 has a generally annular configuration that that is concentrically disposed about the axis X. The shoulder 132 is positioned along the axis X between the threads 130 and the first end 120 of the body 118. The shoulder 132 has an abutment surface 134 orthogonal to the axis X, as shown in FIGS. 2 and 3. The abutment surface 134 faces the threads 130 and the second end 122 of the body 118.

As shown in FIGS. 2 and 3, the compressor 24 may include a protrusion 136 extending into the compressor bore 104 and configured to engage the shoulder 132 of the tie-bolt 116. As such, the protrusion 136 and the shoulder 132 have corresponding and complementary configurations. More specifically, the protrusion 136 extends radially toward and surrounds the axis X. Accordingly, the protrusion 136 has a generally annular configuration that that is concentrically disposed about the axis X. The protrusion 136 has a contact surface 138 (FIG. 10) orthogonal to the axis X. The contact surface 138 faces the abutment surface 134 of the shoulder 132 of the tie-bolt 116 and is configured to engage the abutment surface 134, as will be described in greater detail below.

The shoulder 132 engages the compressor 24 and the threads 130 engage the turbine 28. More specifically, the turbine 28 includes threads 140 extending into the turbine bore 102 to engage the threads 130 of the tie-bolt 116. The threads 140 of the turbine 28 are disposed on the turbine shaft 106 and are positioned adjacent the neck 110. The body 118 of the tie-bolt 116 is configured to extend along the axis X across the interface between the compressor 24 and the turbine 28, with the protrusion 136 of the compressor 24 disposed along the axis X between the shoulder 132 of the tie-bolt 116 and the threads 140 of the turbine 28.

The engagement of the threads 130 of the tie-bolt 116 with the threads 140 of the turbine 28 is configured to move the tie-bolt 116 along the axis X and move the shoulder 132 into contact with the protrusion 136. More specifically, rotation of the tie-bolt 116 in a first rotational direction about the axis X (e.g., clockwise rotation) causes the threads 130 of the tie-bolt 116 to engage and move along the axis X toward the turbine 28. On the other hand, rotation of the tie-bolt 116 in a second rotational direction about the axis X, opposite the first rotational direction, (e.g., counter-clockwise rotation) causes the threads 130 of the tie-bolt 116 to engage and move along the axis X away from the turbine 28. Since the protrusion 136 on the compressor 24 is disposed between the shoulder 132 of the tie-bolt 116 and the threads 140 of the turbine 28, rotation of the tie-bolt 116 in the first rotational direction moves the shoulder 132 of the tie-bolt 116 along the axis X toward the turbine 28 and into engagement with the protrusion 136 of the compressor 24, which moves the compressor 24 and the turbine 28 toward one another along the axis X until the neck 110 of the turbine 28 engages the compressor shaft 108 of the compressor 24. At this position, tensile forces within the tie-bolt 116 between the threads 130 and the shoulder 132 of the tie-bolt 116, acting on the threads 140 of the turbine 28 and the protrusion 136 of the compressor 24, respectively, fix the compressor 24 with the turbine 28. Rotation of the tie-bolt 116 in the second rotational direction moves the shoulder 132 of the tie-bolt 116 along the axis X away from the turbine 28 and out of engagement with the protrusion 136 of the compressor 24, allowing for independent movement of the compressor 24 relative to the turbine 28 for disassembly, servicing, etc.

As shown in FIG. 4, the tie-bolt 116 includes an engagement portion 142 adjacent the bore 128 for engagement by a tool 143 extending through the bore 128. In the embodiment shown in FIG. 4, the engagement portion 142 is disposed adjacent the first end 120 of the body 118. However, the engagement portion 142 may be disposed on any suitable portion of the body 118.

The engagement portion 142 may define a plurality of channels 144 spaced from one another circumferentially about the axis X. The engagement portion 142 includes a pair of engagement surfaces 146 disposed with each of plurality of channels 144. Each pair of engagement surfaces 146 oppose one another and extend transverse to the axis X for engaging the tool 143 when the tool 143 rotates about the axis X in the first rotational direction or the second rotational direction. Each pair of engagement surfaces 146 extend in a planar configuration radially from the axis X, allowing the pair of engagement surfaces 146 to abut the tool 143 receive a force normal to the axis X to induce a torque and rotation on the tie-bolt 116.

Each of the plurality of channels 144 includes a radial opening 148 between the bore 128 and the channel 144. Furthermore, the engagement portion 142 defines a longitudinal opening 150 at each of the plurality of channels 144, with each of the longitudinal opening 150 disposed at the first end 120 and opening individually into each of the channels 144. The radial openings 148 allow the tool 143 to extend orthogonal to the axis X into the channels 144, which allows access of the tool 143 to the tie-bolt 116 from within the bore 128. The longitudinal openings 150 allow selective disposition of the tool 143 within plurality of channels 144 by moving the tool 143 along the axis X, which will be better understood through the further description below.

FIGS. 4-6 schematically depict perspective views of the tool 143 for use with the tie-bolt 116 for coupling the turbine 28 with the compressor 24 in the turbine engine 10. The tool 143 is configured to access the tie-bolt 116 through the bore 128 of the tie-bolt 116. In the embodiments shown in FIGS. 2 and 3, the tool 143 is configured to access the tie-bolt 116 from the exhaust section 76 of the turbine engine 10. More specifically, the tool 143 may be inserted into the turbine bore 102 of the turbine 28 near the exhaust section 76 and may be moved through the turbine bore 102 and the compressor bore 104 until the tool 143 is adjacent the tie-bolt 116. The tool 143 is sized to fit through the bore 128 of the tie-bolt 116 and along a path to the bore 128 of the tie-bolt 116 (e.g., through the turbine bore 102 or the compressor bore 104). As such, openings along the path (e.g., the turbine bore 102 or the compressor bore 104) should have a diameter that is greater than or equal to a diameter of the tool 143. Accordingly, the tie-bolt 116 and the tool 143 described herein allow for access to the tie-bolt 116 through comparatively small openings (e.g., the turbine bore 102 or the compressor bore 104) and/or without disassembly of at least a portion of the turbine engine 10 to access the tie-bolt 116. It is to be appreciated that a diameter of the turbine bore 102 and a diameter of the compressor bore 104 may vary along the axis X. In one embodiment, a minimum diameter D1 of the turbine bore 102 is between 0.5 inch and 5.2 inch. The minimum diameter D1 of the turbine bore 102 refers to the smallest diameter of the turbine bore 102 along the axis X (accounting for variations in the diameter of the turbine bore 102 along the axis X). In one embodiment, the bore 128 of the tie-bolt 116 has a diameter D2 that is greater than or equal to the minimum diameter D1 of the turbine bore 102. As such, the minimum diameter D1 of the turbine bore 102 may be reduced in comparison to the prior art, which improves the load carrying capability of the turbine 28 and increases the rotational speed of the turbine engine 10.

The tool 143 includes a sleeve 152 extending along the axis X between a first sleeve end 154 and a second sleeve end 156. The sleeve 152 has an external surface 158 and an internal surface 160 defining a sleeve bore 162 that extends therethrough along the axis X. The sleeve 152 is configured to be disposed within the turbine bore 102 of the turbine 28 and the compressor bore 104 of the compressor 24. In the embodiment shown in FIGS. 4-10, both the external surface 158 and the internal surface 160 of the sleeve 152 have a substantially cylindrical configuration such that the sleeve 152 is shaped similar to a pipe. Furthermore, the sleeve 152 is sized to extend longitudinally within the turbine bore 102 and/or the compressor bore 104. However, the sleeve 152 may have any suitable shape and configuration for accessing the tie-bolt 116 within the bore 128.

As shown in FIGS. 4-6, the tool 143 further includes a plurality of fingers 164 spaced circumferentially about, and extending outwardly from, the axis X. Furthermore, the sleeve 152 defines a plurality of apertures 166 spaced circumferentially about the axis X and individually aligned with the plurality of fingers 164. The plurality of fingers 164 are at least partially disposed within the sleeve bore 162 of the sleeve 152 and configured to move through the plurality of apertures 166 between the retracted position and the extended position. More specifically, each of the plurality of fingers 164 include a base 168 that extends longitudinally along the axis X and a projection 170 that extends from the base 168 generally orthogonal to the axis X.

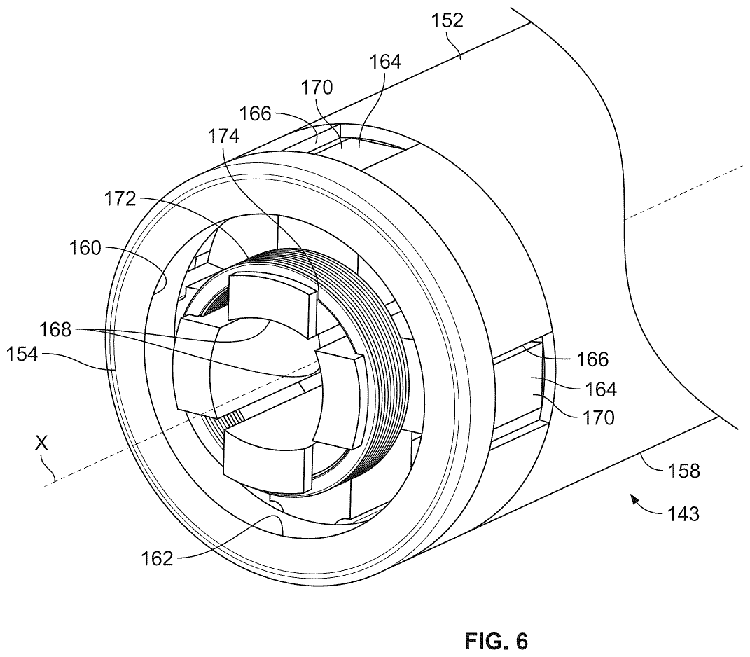

The tool 143 further includes a spring 172 in engagement with the plurality of fingers 164 and configured to bias the plurality of fingers 164 toward the axis X. Each of the plurality of fingers 164 defines a spring channel 174. More specifically, the base 168 of each of the plurality of fingers 164 defines the spring channel 174, with the spring 172 wrapped around the axis X and disposed within each of the spring channels 174. In the embodiment shown in FIGS. 5 and 6, the spring 172 is configured as a coil that is wound around the plurality of fingers 164 radially bias the plurality of fingers 164 toward the axis X. However, the spring 172 may have any suitable configuration for biasing the plurality of fingers 164.

The tool 143 further includes a shaft 176 extending along the axis X. The shaft 176 is configured to be inserted into the sleeve bore 162 of the sleeve 152 at the second sleeve end 156 and move toward the first sleeve end 154, as shown in FIGS. 8-10. The shaft 176 is configured to engage and move the plurality of fingers 164, against the bias of the spring 172, away from axis X from a retracted position to an extended position in which the plurality of fingers 164 extend beyond the external surface 158 of the sleeve 152 for engagement with the tie-bolt 116. More specifically, the shaft 176 is configured to engage the base 168 of each of the plurality of fingers 164. The base 168 of each of the plurality of fingers 164 slide along the shaft 176 as the shaft 176 moves from the second sleeve end 156 to first sleeve end 154. The shaft 176 has a substantially cylindrical configuration (FIG. 5) that moves the each of the bases 168 radially outward from the retracted position to the extended position.

The shaft 176 may taper outwardly from the axis X from the first sleeve end 154 of the sleeve 152 to the second sleeve end 156 of the sleeve 152 to progressively move the plurality of fingers 164 from the retracted position to the extended position. More specifically, the shaft 176 may have a transition portion 178 adjacent that includes the taper that initiates engagement of the shaft 176 with the base 168 of each of the plurality of fingers 164 as the shaft 176 moves from the second sleeve end 156 toward the first sleeve end 154. Accordingly, the transition portion 178 of the shaft 176 may have a substantially conical configuration that incorporates the taper.

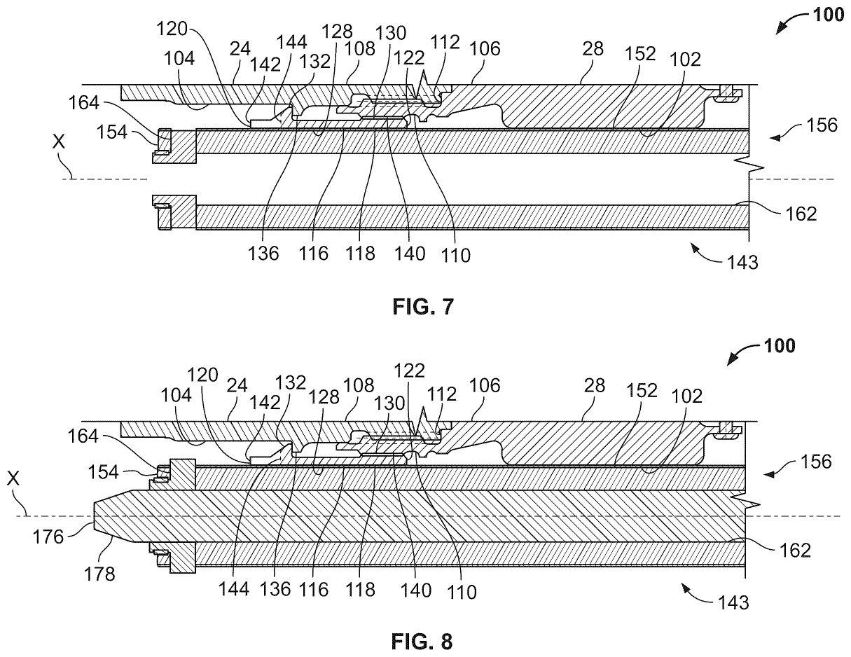

The operation of using the tool 143 to engage and rotate the tie-bolt 116 in the second rotational direction to disconnect the compressor 24 from the turbine 28 will now be described in detail and with reference to FIGS. 7-10.

FIG. 7 shows an embodiment of the rotational assembly 100 in which the tie-bolt 116 is coupled with the compressor 24 and the turbine 28, thereby fixing the compressor 24 with the turbine 28. To disconnect the compressor 24 from the turbine 28 (e.g., for disassembly, repair, maintenance, etc.), the sleeve 152 of the tool 143 is inserted into the turbine bore 102 along the axis X from the exhaust section 76 of the turbine engine 10. The sleeve 152 is translated along the axis X through the bore 128 of the tie-bolt 116 and into the compressor bore 104 of the compressor 24. The plurality of apertures 166 are positioned outside of the bore 128 of the tie-bolt 116, adjacent the first end 120 of the tie-bolt 116.

FIG. 8 shows the insertion of the shaft 176 of the tool 143 into the sleeve 152 of the tool 143. The transition portion 178 of the shaft 176 engages the base 168 of each of the plurality of fingers 164 and moves the fingers 164 outwardly from the axis X from the retracted position to the extended position. In the extended position, the projection 170 of each of the plurality of fingers 164 extend past the external surface 158 of the sleeve 152. The shaft 176 remains within the sleeve 152 to retain the plurality of fingers 164 in the extended position.

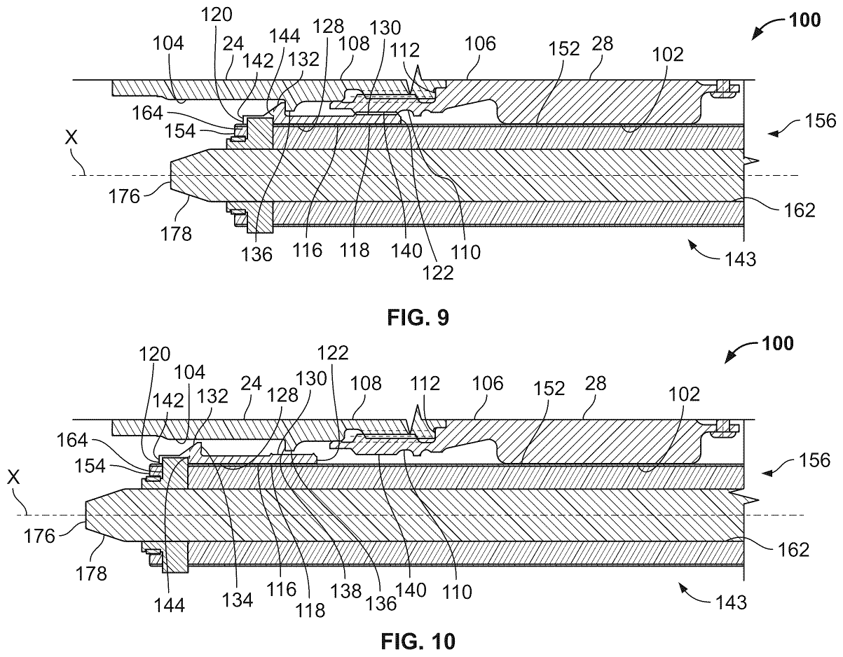

FIG. 9 shows the tool 143, which includes the shaft 176 within the sleeve 152, moved as a unit toward the tie-bolt 116 to dispose the plurality of fingers 164 individually within the plurality of channels 144 of the engagement portion 142 of the tie-bolt 116. The tool 143 is then rotated in the second rotational direction, causing the plurality of fingers 164 to engage the engagement surfaces 146 within the plurality of channels 144 and rotate the tie-bolt 116 in the second rotational direction. Rotation of the tie-bolt 116 in the second rotational direction moves the tie-bolt 116 along the axis X away from the turbine 28 until the threads 130 of the tie-bolt 116 disengage the threads 140 of the turbine 28, as shown in FIG. 10. With the threads 130 of the tie-bolt 116 disengaged from the threads 140 of the turbine 28, the tie-bolt 116 is disconnected from the compressor 24 and the turbine 28, thereby disconnecting the compressor 24 from the turbine 28.

To remove the tool 143 from within the turbine engine 10, the shaft 176 is moved out of the sleeve bore 162 through the second sleeve end 156, thereby moving the plurality of fingers 164 from the extended position to the retracted position. The sleeve 152 is then removed from the bore 128 of the tie-bolt 116, the compressor bore 104, and the turbine bore 102 by translating along the axis X toward the exhaust section 76 of the turbine engine 10.

In one embodiment, the tool 143 is configured to be rotated in the first rotational direction and/or the second rotational direction manually (e.g., by physical manipulation and exertion of a technician). However, the tool 143 may be configured to be rotated by device, such as a hydraulic wrench, a pneumatic wrench, an electric wrench, etc.

The operation of using the tool 143 to engage and rotate the tie-bolt 116 in the first rotational direction to connect the compressor 24 with the turbine 28 is similar to the operation of using the tool 143 to engage and rotate the tie-bolt 116 in the second rotational direction to disconnect the compressor 24 from the turbine 28.

With the tie-bolt 116, the compressor 24, and the turbine 28 disconnected from one another, the sleeve 152 of the tool 143 is inserted into the turbine bore 102 along the axis X from the exhaust section 76 of the turbine engine 10. The sleeve 152 is translated along the axis X through the bore 128 of the tie-bolt 116 and into the compressor bore 104 of the compressor 24. The plurality of apertures 166 are positioned outside of the bore 128 of the tie-bolt 116, adjacent the first end 120 of the tie-bolt 116. The shaft 176 of the tool 143 is inserted into the sleeve 152 of the tool 143. The transition portion 178 of the shaft 176 engages the base 168 of each of the plurality of fingers 164 and moves the fingers 164 outwardly from the axis X from the retracted position to the extended position. In the extended position, the projection 170 of each of the plurality of fingers 164 extend past the external surface 158 of the sleeve 152. The shaft 176 is left within the sleeve 152 to retain the plurality of fingers 164 in the extended position. The tool 143 is then moved as a unit toward the tie-bolt 116 to dispose the plurality of fingers 164 individually within the plurality of channels 144 of the engagement portion 142 of the tie-bolt 116. The tool 143 is then rotated in the first rotational direction, causing the plurality of fingers 164 to engage the engagement surfaces 146 within the plurality of channels 144 and rotate the tie-bolt 116 in the first rotational direction.

Rotation of the tie-bolt 116 in the first rotational direction causes the threads 130 of the tie-bolt 116 to engage the threads 140 of the turbine 28 and moves the tie-bolt 116 along the axis X toward the turbine 28. The shoulder 132 of the tie-bolt 116 engages the protrusion 136 of the compressor 24, thereby moving the compressor 24 with the tie-bolt 116 toward the turbine 28. The compressor 24 and the turbine 28 move toward one another until the neck 110 of the turbine 28 abuts the compressor shaft 108 of the compressor 24, thereby connecting the compressor 24 with the turbine 28.

From the above, it is to be appreciated that defined herein is a rotational assembly for a turbine engine that include a turbine rotatable about an axis and defining a turbine bore that extends along the axis and a compressor rotatable about the axis and defining a compressor bore that extends along the axis. The rotational assembly includes a tie-bolt disposed within the turbine bore and the compressor bore for coupling a turbine with a compressor in a turbine engine. The tie-bolt includes a body that extends longitudinally along an axis and has an exterior surface and an interior surface that defines a bore extending therethrough along the axis. The tie-bolt further includes threads disposed along the exterior surface of the body and configured to engage at least one of the turbine and the compressor. The tie-bolt further includes an engagement portion adjacent the bore for engagement by a tool extending through the bore.

In addition, defined herein is a tool for use with the tie-bolt for coupling the turbine with the compressor in the turbine engine. The tool includes a sleeve that extends along an axis between a first sleeve end and a second sleeve end. The sleeve has an external surface and an internal surface defining a sleeve bore that extends therethrough along the axis. The sleeve is configured to be disposed within a turbine bore of the turbine and a compressor bore of the compressor. The tool further includes a plurality of fingers spaced circumferentially about, and extending outwardly from, the axis, and a spring in engagement with the plurality of fingers and configured to bias the plurality of fingers toward the axis. The tool further includes a shaft extending along the axis. The shaft is configured to be inserted into the sleeve bore of the sleeve at the second sleeve end and move toward the first sleeve end. The shaft is configured to engage and move the plurality of fingers, against the bias of the spring, away from axis from a retracted position to an extended position in which the plurality of fingers extend beyond the external surface of the sleeve for engagement with the tie-bolt.

The embodiments described herein utilize the tie-bolt having the bore extending therethrough along the axis for insertion of the tool therethrough to access the tie-bolt. In turn, the tie-bolt may be disposed further within the turbine engine and may be accessed by the tool through the diameter of the bore itself. As such, labor is reduced in accessing the tie-bolt while the compressor and the turbine may be configured for higher performance.

Further aspects of the embodiments described herein are provided by the subject matter of the following clauses:

A tie-bolt for coupling a turbine with a compressor in a turbine engine; the tie-bolt comprising: a body that extends longitudinally along an axis and has an exterior surface and an interior surface that defines a bore extending therethrough along the axis; threads disposed along the exterior surface of the body and configured to engage at least one of the turbine and the compressor; and an engagement portion adjacent the bore for engagement by a tool extending through the bore.

The tie-bolt of any preceding clause, further comprising a shoulder extending from the body to engage one of the turbine and the compressor.

The tie-bolt of any preceding clause, wherein the shoulder extends radially away from the axis.

The tie-bolt of any preceding clause, wherein the shoulder has an abutment surface orthogonal to the axis.

The tie-bolt of any preceding clause, wherein the shoulder surrounds the body about the axis.

The tie-bolt of any preceding clause, wherein the shoulder engages the compressor and the threads engage the turbine.

The tie-bolt of any preceding clause, wherein the engagement portion comprises a pair of engagement surfaces opposing one another and extending transverse to the axis for engaging the tool when the tool rotates about the axis in a first rotational direction or a second rotational direction, opposite the first rotational direction.

The tie-bolt of any preceding clause, wherein the pair of engagement surfaces each extend in a planar configuration radially from the axis.

The tie-bolt of any preceding clause, wherein the engagement portion defines a channel comprising the pair of engagement surfaces and a radial opening between the bore and the channel.

The tie-bolt of any preceding clause, wherein the body extends along the axis between a first end and a second end, with the engagement portion disposed at the first end and defining a longitudinal opening at the first end that opens into the channel.

The tie-bolt of any preceding clause, wherein the engagement portion defines a plurality of the channel spaced from one another circumferentially about the axis.

A rotational assembly for a turbine engine, comprising: a turbine rotatable about an axis and defining a turbine bore that extends along the axis; a compressor rotatable about the axis and defining a compressor bore that extends along the axis; a tie-bolt disposed within the turbine bore and the compressor bore for coupling a turbine with a compressor in a turbine engine, the tie-bolt comprising: a body that extends longitudinally along an axis and has an exterior surface and an interior surface that defines a bore extending therethrough along the axis; threads disposed along the exterior surface of the body and configured to engage at least one of the turbine and the compressor; and an engagement portion adjacent the bore for engagement by a tool extending through the bore.

The rotational assembly of any preceding clause, wherein the tie-bolt includes a shoulder extending from the body and the compressor includes a protrusion extending into the compressor bore and configured to engage the shoulder of the tie-bolt.

The rotational assembly of any preceding clause, wherein the turbine includes threads extending into the turbine bore to engage the threads of the tie-bolt, wherein the engagement of the threads of the tie-bolt with the threads of the turbine is configured to move the tie-bolt along the axis and move the shoulder into contact with the protrusion.

The rotational assembly of any preceding clause, wherein the engagement portion defines a plurality of channels spaced from one another circumferentially about the axis and comprises a pair of engagement surfaces disposed within each of the plurality of channels for engaging the tool.

The rotational assembly of any preceding clause, wherein the bore of the tie-bolt has a diameter that is greater than or equal to the minimum diameter of the turbine bore.

The rotational assembly of any preceding clause, wherein the turbine comprises a turbine shaft extending along the axis and the compressor comprising a compressor shaft extending along the axis and configured to nest with the turbine shaft.

A tool for use with a tie-bolt for coupling a turbine with a compressor in a turbine engine, the tool comprising: a sleeve extending along an axis between a first sleeve end and a second sleeve end, with the sleeve having an external surface and an internal surface defining a sleeve bore that extends therethrough along the axis, and with the sleeve configured to be disposed within a turbine bore of the turbine and a compressor bore of the compressor; a plurality of fingers spaced circumferentially about, and extending outwardly from, the axis; a spring in engagement with the plurality of fingers and configured to bias the plurality of fingers toward the axis; and a shaft extending along the axis, with the shaft configured to be inserted into the sleeve bore of the sleeve at the second sleeve end and move toward the first sleeve end, with the shaft configured to engage and move the plurality of fingers, against the bias of the spring, away from axis from a retracted position to an extended position in which the plurality of fingers extend beyond the external surface of the sleeve for engagement with the tie-bolt.

The tool of any preceding clause, wherein the shaft tapers outwardly from the axis from the first sleeve end of the sleeve to the second sleeve end of the sleeve to progressively move the plurality of fingers from the retracted position to the extended position.

The tool of any preceding clause, wherein the sleeve defines a plurality of apertures spaced circumferentially about the axis and individually aligned with the plurality of fingers, with the plurality of fingers at least partially disposed within the sleeve bore of the sleeve and configured to move through the plurality of apertures between the retracted position and the extended position.

The tool of any preceding clause, wherein each of the plurality of fingers defines a spring channel, wherein the spring is wrapped around the axis and disposed within each of the spring channels.

A method of rotating a tie-bolt of a turbine engine with a tool, the method comprising: moving a sleeve of a tool through a bore of the tie-bolt along an axis; moving a shaft of the tool through a sleeve bore of the sleeve; engaging a plurality of fingers of the tool with the shaft; moving the plurality of fingers with the shaft from a retracted position to an extended position; engaging the plurality of fingers with an engagement portion of the tie-bolt; and rotating the tool and the tie-bolt about the axis.

The method any preceding clause, further comprising moving the sleeve through a turbine bore of a turbine along the axis before moving the sleeve of the tool through the bore of the tie-bolt along an the axis.

The method of any preceding clause, wherein rotating the tool and the tie-bolt about the axis further comprises rotating the tool in a first rotational direction to connect a compressor with a turbine.

The method of any preceding clause, wherein rotating the tool in the first rotational direction to connect the compressor with the turbine further comprises engaging a shoulder of the tie-bolt with a protrusion of the compressor.

The method of any preceding clause, wherein rotating the tool and the tie-bolt about the axis further comprises rotating the tool in a second rotational direction to disconnect a compressor from a turbine.

The method of any preceding clause, wherein engaging the plurality of finger with the engagement portion of the tie-bolt further comprises moving the tool along the axis to engage the plurality of fingers with the engagement portion of the tie-bolt.

The method of any preceding clause, wherein rotating the tool and the tie-bolt about the axis further comprises engaging threads of the tie-bolt with threads of a turbine

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. A tie-bolt for coupling a turbine with a compressor in a turbine engine; the tie-bolt comprising:
a body that extends longitudinally along an axis and has an exterior surface and an interior surface that defines a bore extending therethrough along the axis;
threads disposed along the exterior surface of the body and configured to engage at least one of the turbine and the compressor; and
an engagement portion adjacent the bore for engagement by a tool extending through the bore.

2. The tie-bolt of claim 1, further comprising a shoulder extending from the body to engage one of the turbine and the compressor.

3. The tie-bolt of claim 2, wherein the shoulder extends radially away from the axis.

4. The tie-bolt of claim 3, wherein the shoulder has an abutment surface orthogonal to the axis.

5. The tie-bolt of claim 3, wherein the shoulder surrounds the body about the axis.

6. The tie-bolt of claim 2, wherein the shoulder engages the compressor and the threads engage the turbine.

7. The tie-bolt of claim 1, wherein the engagement portion comprises a pair of engagement surfaces opposing one another and extending transverse to the axis for engaging the tool when the tool rotates about the axis in a first rotational direction or a second rotational direction, opposite the first rotational direction.

8. The tie-bolt of claim 7, wherein the pair of engagement surfaces each extend in a planar configuration radially from the axis.

9. The tie-bolt of claim 7, wherein the engagement portion defines a channel comprising the pair of engagement surfaces and a radial opening between the bore and the channel.

10. The tie-bolt of claim 9, wherein the body extends along the axis between a first end and a second end, with the engagement portion disposed at the first end and defining a longitudinal opening at the first end that opens into the channel.

11. The tie-bolt of claim 9, wherein the engagement portion defines a plurality of the channel spaced from one another circumferentially about the axis.

12. A rotational assembly for a turbine engine, comprising:
a turbine rotatable about an axis and defining a turbine bore that extends along the axis;
a compressor rotatable about the axis and defining a compressor bore that extends along the axis; and
a tie-bolt disposed within the turbine bore and the compressor bore for coupling a turbine with a compressor in a turbine engine, the tie-bolt comprising:
a body that extends longitudinally along an axis and has an exterior surface and an interior surface that defines a bore extending therethrough along the axis;
threads disposed along the exterior surface of the body and configured to engage at least one of the turbine and the compressor; and
an engagement portion adjacent the bore for engagement by a tool extending through the bore.

13. The rotational assembly of claim 12, wherein the tie-bolt includes a shoulder extending from the body and the compressor includes a protrusion extending into the compressor bore and configured to engage the shoulder of the tie-bolt.

14. The rotational assembly of claim 13, wherein the turbine includes threads extending into the turbine bore to engage the threads of the tie-bolt, wherein the engagement of the threads of the tie-bolt with the threads of the turbine is configured to move the tie-bolt along the axis and move the shoulder into contact with the protrusion.

15. The rotational assembly of claim 12, wherein the engagement portion defines a plurality of channels spaced from one another circumferentially about the axis and comprises a pair of engagement surfaces disposed within each of the plurality of channels for engaging the tool.

16. The rotational assembly of claim 12, wherein the bore of the tie-bolt has a diameter that is greater than or equal to the minimum diameter of the turbine bore.

17. A tool for use with a tie-bolt for coupling a turbine with a compressor in a turbine engine, the tool comprising:
a sleeve extending along an axis between a first sleeve end and a second sleeve end, with the sleeve having an external surface and an internal surface defining a sleeve bore that extends therethrough along the axis, and with the sleeve configured to be disposed within a turbine bore of the turbine and a compressor bore of the compressor;
a plurality of fingers spaced circumferentially about, and extending outwardly from, the axis;
a spring in engagement with the plurality of fingers and configured to bias the plurality of fingers toward the axis; and
a shaft extending along the axis, with the shaft configured to be inserted into the sleeve bore of the sleeve at the second sleeve end and move toward the first sleeve end, with the shaft configured to engage and move the plurality of fingers, against the bias of the spring, away from axis from a retracted position to an extended position in which the plurality of fingers extend beyond the external surface of the sleeve for engagement with the tie-bolt.

18. The tool of claim 17, wherein the shaft tapers outwardly from the axis from the first sleeve end of the sleeve to the second sleeve end of the sleeve to progressively move the plurality of fingers from the retracted position to the extended position.

19. The tool of claim 17, wherein the sleeve defines a plurality of apertures spaced circumferentially about the axis and individually aligned with the plurality of fingers, with the plurality of fingers at least partially disposed within the sleeve bore of the sleeve and configured to move through the plurality of apertures between the retracted position and the extended position.

20. The tool of claim 17, wherein each of the plurality of fingers defines a spring channel, wherein the spring is wrapped around the axis and disposed within each of the spring channels.
